(19) United States
(12) Patent Application Publication
(10) Pub. No.: US 2004/0149533 A1
(43) Pub. Date: Aug. 5, 2004

(54) Cable management and contact monitoring system

(76) Inventor: Joanne Milano, Burlington, VT (US)

Correspondence Address: Law Offices Eric R. Benson, Esq., Champlain Station, Box 65238, Burlington, VT, 05406-5238, US

(21) Appl. No.: 10/762,926

(22) Filed: Jan. 22, 2004

Related U.S. Application Data
(60) Provisional application No. 60/442,269, filed on Jan. 24, 2003.

(51) Int. Cl. H02G 11/02

(52) U.S. Cl. 191/12.4

(57) ABSTRACT

This invention relates to a cable management and contact monitoring system. This system allows a user to quickly, easily and neatly store the conductive cables of various devices such as computers, fetal monitors, defibrilators, heart monitors and therapeutic electrical stimulation machines in a clinical setting and aids in detecting and troubleshooting connection problems which may occur with these devices. The system is comprised of a spring powered cable retraction device with a manual or automatic stop mechanism, a slip ring connector, contact sensors and an indicator light and/or audible signal circuit.

### BACKGROUND ART

Retractable conductors are well known in the prior art. For instance electrical cords for portable lighting and extension cords are commonly used in a multitude of settings from home uses to commercial uses such as those of automotive mechanics. Also, the use of contact detection failure devices is also known in the prior art by use of indicators of various types both visual and audible.

While the use of these devices in the prior art are common for two to three conductor extension cord types of uses, the prior art is devoid of the application of these devises to such uses as computers in various settings, fetal monitors, defibrillators, heart monitors and therapeutic electrical stimulation machines for use in clinical settings. The current technology for conductive connectors of these devices to their respective output devices is most generally conductive wires or cables with functional connectors on each end to connect the devices. The consequences of the use of these types of connectors results in a tangle of cables as in the use of computers with no cable specific failure detection means.

Also the prior art usage of conductive connectors and cables in the use of devices such as fetal monitors, defibrillators, heart monitors and therapeutic electrical stimulation machines in a clinical setting results in these connectors and cables being moved, used and stored frequently which most often results in the tangling and crimping of these cables causing frequent pre-mature failure as the cable breaks or wears out. The prior art cables in these clinical settings also do not utilize a cable failure detection means.

It is well known that the cables and cords associated with modern medical equipment can be difficult to manage in a clinical setting. The cables become tangled and draped in high activity areas leading to interference with the clinician's actions or the patient's comfort. Invariably cables are stressed and consequently are prone to premature failure. Cable failures will result in an operational fault, which is generally detected by the patient. This fault could be due to any one of a number of components including the cable. Any troubleshooting aid will help the clinician rectify the problem and resume treating the patient.

There are many passive means of managing cables including cableways and various ties but none facilitate the level of activity needed in a clinical environment. Thus it is the objective of the present invention to provide an active system capable of satisfying the demanding cable management requirements such as in a clinical environment and that provides some troubleshooting support in the event of a cable failure.

While each of these prior art cable management and contact monitoring systems fulfill their respective particular objectives and requirements, and are most likely quite functional for their intended purposes, it will be noticed that none of the prior art cited disclose an apparatus and/or method that is portable, rugged, and lightweight and that can be used for computers in various settings, fetal monitors, defibrilators, heart monitors and therapeutic electrical stimulation machines in a clinical setting to meet the operational requirements of the user. Also, the prior art does not provide the user with a means to directly detect conductor cable failure.

As such, there apparently still exists the need for a new and improved cable management and contact monitoring system to maximize the conductor cable life-span by storing the cable in a retracted position while allowing monitoring of the cable's integrity during its use.

In this respect, the present invention disclosed herein substantially corrects these problems and fulfills the need for such a device.

### DISCLOSURE OF THE INVENTION

In view of the foregoing limitations inherent in the known types of cable management and contact monitoring systems now present in the prior art, the present invention provides an apparatus that has been designed to provide the following features for a user:

a cable management and contact monitoring system that can be interfaced with a wide range of devices such as computers and computer input or output devices, fetal monitors, defibrilators, heart monitors and therapeutic electrical stimulation machines in a clinical setting;

cable retraction onto a cable drum for easy cable storage;

stored cable is protected from excessive wear and crimping while not in use;

provides any easy to view LED indicator or audible signal (or combination thereof) that indicates the presence or absence of contact between the device and its intended connection by the invention such as another computer, a printer, monitor or other computer input or output device, or in the case of a medical application to a patient; and

manual or automatic braking of the cable retraction mechanism.

The present invention in its preferred embodiment is a self-contained system comprised of a housing, slip-ring connector, a spring actuated cable reel with manual stop and an indicator light circuit. The system will store cable on the reel when not in use. To operate the invention the operator will pull the braking mechanism, draw out the cable end out to the desired length and release the brake. A green indicator light will show indicate normal operation. A yellow lamp will light to indicate an open, or failure, in the electrode circuit.

These features are improvements which are patently distinct over similar devices and methods which may already be patented or commercially available. As such, the general purpose of the present invention, which will be described subsequently in greater detail, is to provide a field designed apparatus and method of use that incorporates the present invention. There are many additional novel features directed to solving problems not addressed in the prior art.

To attain this the present invention generally comprises four main components: 1) the core assembly; 2) the rotor assembly; 3) the brake assembly; and 4) the input cord assembly.

These together with other objects of the invention, along with the various features of novelty which characterize the invention, will be pointed out with particularity in the claims which are annexed hereto and forming a part of this patent application. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is an exploded perspective view of the four wire cable embodiment of the invention including references to various component assemblies.

FIG. 2 is an exploded perspective view of the core assembly of the four wire cable embodiment of the invention.

FIG. 3 is an exploded perspective view of the rotor assembly of the four wire cable embodiment of the invention.

FIG. 4 is an exploded perspective view of the manual brake assembly of the four wire cable embodiment of the invention.

FIG. 5 is a perspective view of the input cord assembly of the four wire cable embodiment of the invention.

### BEST MODES FOR CARRYING OUT THE INVENTION

I. Preferred Embodiments

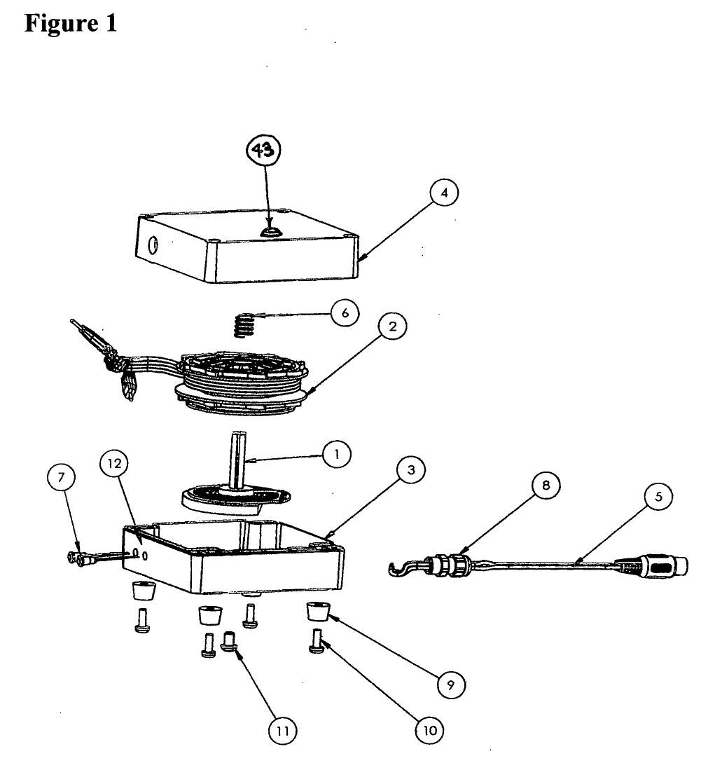

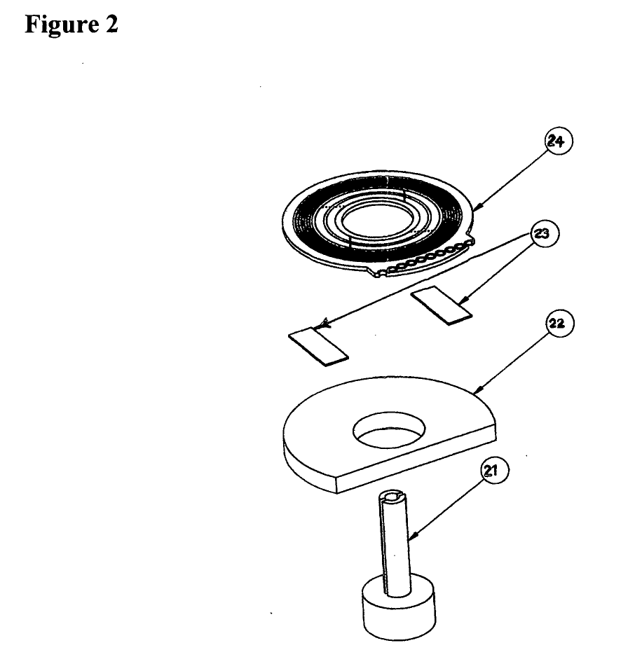

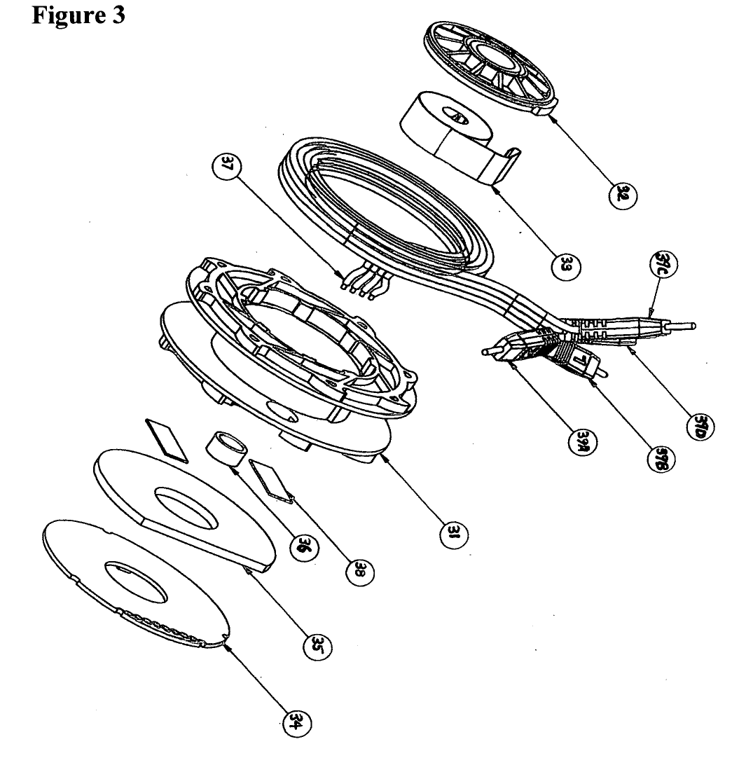

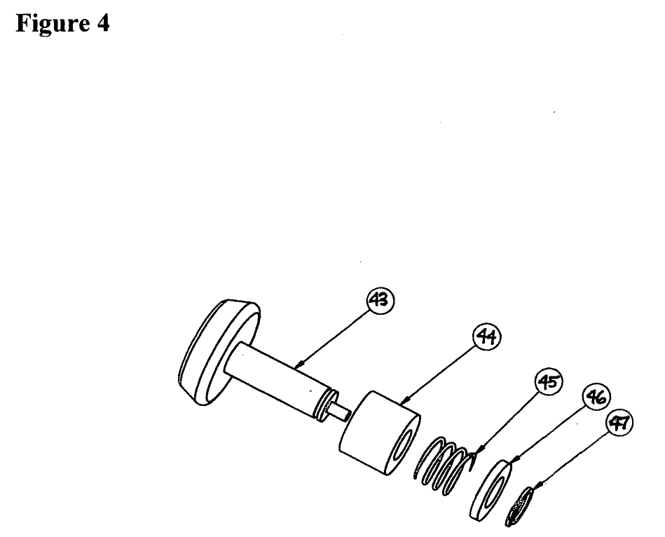

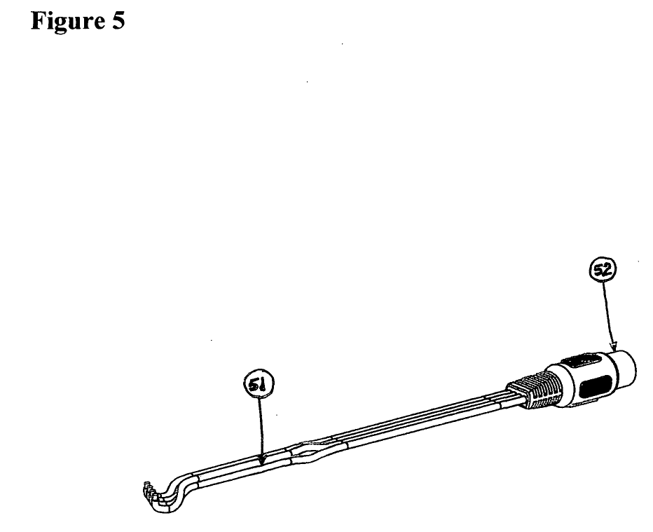

With reference now to the drawings, and in particular to FIGS. 1-5 thereof, a new and novel apparatus for a four wire cable embodiment cable management and contact monitoring system embodying the principles and concepts of the present invention is depicted in these drawings as comprising four major components, the core assembly, the rotor assembly, the brake assembly and the input cord assembly and are generally depicted with each assembly's respective component parts in FIG. 2, FIG. 3, FIG. 4 and FIG. 5 respectively.

General Description of Reference Numerals in the Description and Drawings Any actual dimensions listed are those of the preferred embodiment. Actual dimensions or exact hardware details and means may vary in a final product or most preferred embodiment and should be considered means for so as not to narrow the claims of the patent.

List and Description of component parts of the invention:

(1) Core Assembly

(2) Rotor Assembly

(3) Box Base

(4) Box Top

(5) Input Cord Assembly

(6) Compression Spring

(7) LED Indicators

(8) “Skintop” PG7 Gland

(9) Neoprene Equipment Foot

(10) Pan Head Machine Screws

(11) SBHCS Screw

(12) M6 Hex Jam Nut

(21) Spindle

(22) Base Standoff

(23) Two-Sided Adhesive Tape

(24) Contactor Stator

(31) Cable Drum

(32) Drum Cap

(33) Torsion Spring

(34) Contactor Rotor Assembly

(35) Rotor Backing Plate

(36) Sintered Bronze Bushing

(37) 4-Conductor Input Cable End

(38) Two-Sided Adhesive Tape

(39A) One Pin Connector — Red “2”

(39B) One Pin Connector—Red “1”

(39C) One Pin Connector—Black “2”

(39D) One Pin Connector—Black “1”

(43) Brake Pin

(44) Bushing

(45) Short Compression Spring

(46) Flat Washer

(47) External Retaining Ring

(51) 4-Conductor Input Cable

(52) 4 Pin DIN Connector

### DETAILED DESCRIPTION OF THE PREFERRED EMBODIMENTS

The four wire cable embodiment of the invention as shown in FIG. 1 consists of a Box Top 4 and Box Base 3, which provides support for all assemblies and components. Discrete components include the SBHCS Screw 11, LED Indicator 7 which is functionally connected to the Contactor Stator 24, four Neoprene Equipment Foot 9, Compression Spring 6, and ‘Skintop’ PG7 Gland 8. The individual assemblies include the Core Assembly 1 (further exploded into a perspective view of component parts in FIG. 2), the Rotor Assembly 2 (further exploded into a perspective view of component parts in FIG. 3), the Brake Assembly of which the Brake Pin 43 is shown in FIG. 1 (an exploded perspective view of component parts of which is depicted in FIG. 4), and the Input Cord Assembly 5 (a perspective view of component parts of which is depicted in FIG. 5).

The SBHCS Screw 11 secures the Core Assembly 1 to the Box Base 3. The LED Indicator(s) 7 indicate normal operation and a poor electrode, electronic or electrical connection. A poor connection is indicated by the LED Indicator(s) 7 when a higher than normal resistance is detected by the LED Indicator(s) 7 internal microprocessor and electrical current sensors across the electrodes, electronic or electrical connections (the electrodes, electronic or electrical connections are not shown but are connected while in use to a One Pin Connector—Red “2” 39A, a One Pin Connector—Red “1” 39B, a One Pin Connector—Black “2” 39C, and a One Pin Connector—Black “1” 39D and are also placed in conductive contact with user defined devices or locations for user defined purposes such as with computers, fetal monitors, defibrilators, heart monitors and therapeutic electrical stimulation machines). A poor connection situation that illuminates the LED Indicator(s) 7 would indicate a poor connection as opposed to an open circuit, which would indicate a broken Input Cord Assembly 5 or other problem with the user selected device (a user selected device requiring four conductive leads may be connected to the invention by the 4 Pin DIN Connector 52 of the Input Cord Assembly 5 and would provide the user conduction through the 4 Conductor Cable 37 to another user defined device or patient as in a clinical medical application). In another embodiment the LED Indicator(s) 7 may be replaced with an audible signaling device or used in combination therewith.

The four Neoprene Equipment Foot 9 provide a convenient and stable foundation for the invention. In another embodiment the Neoprene Equipment Foot 9 may be replaced with a Velcro® Strip, a Two-sided adhesive tape, or other attachment means to secure the device as the user may require.

The Compression Spring 6 depicted in FIG. 1 ensures good conductive contact between the Contactor Rotor Assembly 34 and Contactor Stator 24 by providing a small preload force between the conductors thereof by exerting spring tension between the Box Top 4 and the Drum Cap 32. A secondary function of the Compression Spring 6 is to provide a small amount of drag between the Core Assembly 1 and the Rotor Assembly 2. This prevents the 4-Conductor Cable 37 from retracting too quickly. The ‘Skintop®’ PG7 Gland 8 is a bulkhead fitting that reduces stress and strain on the 4-Conductor Input Cable 51 if the Input Cord Assembly 5 is pulled.

As depicted in FIG. 2 the Core Assembly 1 is comprised of the Spindle 21, the Base Standoff 22, Two-Sided Adhesive Tape 23 and a Contactor Stator 24. The Spindle 21 provides a central pivot around which all rotary motion occurs and is slotted to accept and secure the inside end of the Torsion Spring 33. There is a threaded hole in the bottom of the Spindle 21 to accept the SBHCS Screw 11, which secures the Core Assembly 1 to the Box Base 3.

The Base Standoff 22 positions the Contactor Stator 24 at the correct height to make contact with the Contactor Rotor Assembly 34 and provides a rigid flat platform on which to mount the Contactor Stator 24. The Two-sided Adhesive Tape 23 secures the Contactor Stator 24 to the Base Standoff 22.

The conductors on the Input Cord Assembly 5 are soldered to solder pads on the Contactor Stator 24. The Contactor Stator 24 thereby provides a conductive path between the Input Cord Assembly 5 and the Contactor Rotor Assembly 34.

As depicted in FIG. 3 the Rotor Assembly 2 is comprised of a Cable Drum 31, a Drum Cap 32, a Torsion Spring 33, the Contactor Rotor Assembly 34, a Rotor Backing Plate 35, a Sintered Bronze Bushing 36, a Four Conductor Cable 37, a Two Sided Adhesive Tape 38 and a One Pin Connector—Red “2” 39A, a One Pin Connector—Red “1” 39B, a One Pin Connector—Black “2” 39C, and a One Pin Connector—Black “1” 39D. The Cable Drum 31 provides storage volume for the retracted Four Conductor Cable 37.

The Drum Cap 32 contains the Torsion Spring 33. The Torsion Spring 33 provides retraction torque to the Cable Drum 31. The inside end of the Torsion Spring 33 is secured in the slot on the Spindle 21. The outside end of the Torsion Spring 33 is secured to the Cable Drum 31. The torsion of the Torsion Spring 33 is increased as the Four Conductor Cable 37 is withdrawn.

The conductors of the Four Conductor Cable 37 are soldered to the solder pads on the Conductor Rotor Assembly 34. The Contactor Rotor Assembly 34 thereby provides a conductive path between the Four Conductor Cable 37 and the Conductor Stator 24. The Rotor Backing Plate 35 provides a flat and secure mounting surface for the Contactor Rotor Assembly 34.

The Sintered Bronze Bushing 36 allows smooth rotation of the Cable Drum 31 around the Spindle 21. The Sintered Bronze Bushing 36 is press fit into the Cable Drum 31. The Four Conductor Cable 37 provides a conductive path from the Contactor Rotor Assembly 34 to the One Pin Connectors 39A, 39B, 39C, 39D. Two-sided Adhesive Tape 38 is used to secure the Contactor Rotor Assembly 34 to the Rotor Backing Plate 35.

In other various embodiments the One Pin Connectors 39A, 39B, 39C, 39D provide a conductive path between the Four Conductor Cable 37 and the user selected device(s) such as computer input or output devices, electrodes for fetal monitors, defibrillator paddles, electrodes for heart monitors and electrodes for therapeutic electrical stimulation machines in a clinical setting. In these various embodiments the conductive pathway may be comprised of one or more conductors depending upon the needs of the user. In these other embodiments the One Pin Connectors 39A, 39B, 39C, 39D may be replaced with USB computer connections, parallel or serial port connections, telephone jacks, Ethernet connections or standard electrical cords and electrical plugs. In these other embodiments where the conductive pathway involves one or more conductors the Input Cord Assembly 5, the Contactor Stator 24, the Contactor Rotor Assembly 34, and the 4-Conductor Cable 37 would each have at least as many conductors as required by the user selected input and output device(s) all of which are functionally connected as described above in the preferred embodiment. The 4 Pin DIN Connector 52 of the Input Cord Assembly 5 in these other embodiments are replaced with the appropriate connector to the user selected input device such as USB computer connections, parallel or serial port connections, telephone jacks, Ethernet connections or standard electrical cords and electrical plugs.

As depicted in FIG. 4 the Brake Assembly is comprised of a Brake Pin 43, a Bushing 44, a Short Compression Spring 45, a Flat Washer 46 and an External Retaining Ring 47. The Brake Pin 43 engages ribs on the Cable Drum 31 to stop the rotation when the Brake Pin 43 is released. The Bushing 44 allows smooth linear motion of the Brake Pin 43. The Bushing 44 is press-fit into the Box Top 4. The Short Compression Spring 45 provides positive downward force through the Flat Washer 46 and the External Retaining Ring 47 to the Brake Pin 43 to prevent rotation of the Cable Drum 31.

The Flat Washer 46 transmits spring force from the Short Compression Spring 45 to the External Retaining Ring 47. The External Retaining Ring 47 in turn transmits force from the Flat Washer 46 to the Brake Pin 43. In yet another embodiment the Brake Assembly is automatic only requiring the user to retract and detract the cable by pulling on the cable without the need of also pushing the Brake Pin 43 as in the preferred embodiment.

As depicted in FIG. 5 the Input Cord Assembly 5 of the preferred embodiment is comprised of a Four Conductor Input Cable 51 and the Four Pin DIN Connector 52. The Four Conductor Input Cable 51 provides a conductive path from the Contactor Stator 24 to the Four Pin DIN Connector 52. The Four Pin DIN Connector 52 provides a conductive path between the Four Conductor Cable 51 and the user selected input device(s) such as computers, fetal monitors, defibrilators, heart monitors and therapeutic electrical stimulation machines in a clinical setting. In the various other embodiments described above the Four Pin DIN Connector 52 and the Four Conductor Cable 51 may be replaced with other connectors and cables appropriate for the user selected input devices, each of which having the required connector (i.e. USB, telephone jack, extension cord plug, etc.) and the required number of conductors (i.e. wires, cables or other conductive pathway).

While my above descriptions of the invention, its parts, and operations contains many specificities, these should not be construed as limitations on the scope of the invention, but rather as exemplifications of present embodiments thereof. Many other variations are possible, for example, other embodiments, shapes, and sizes of the device can be constructed to fit on or in a device such as computers, fetal monitors, defibrilators, heart monitors and therapeutic electrical stimulation machines. The types of connectors and numbers of conductive pathways can also be changed according to the needs of a user. Also various materials, differing user selected input and output devices, colors and configurations can be employed in the unit's design that would provide interesting embodiment differences to users including such practical designs as would, for instance conceal the unit, or apply the use to a computer and its input or output.

Accordingly, the scope of the invention should be determined not by the embodiments illustrated, but by the claims and their legal equivalents as filed herewith.

Having described my invention, I claim:

1. A cable management and contact monitoring system comprised of:
at least one conductor means;
at least one retraction means about which the conductor means may be retracted to a stored state;
at least one locking means attached to the retraction means capable of locking the locking means when a user draws the conductor means from the retracted stored state to a desired length for use and then maintaining the desired length and the locking means being further capable of unlocking the locking means by the user when the user returns the conductor means to the retracted stored state;
the conductor means further comprising at least one electronically attached contact detection means capable of detecting the integrity of the contact of the conductor means with that of user selected objects to which the conductor means has been attached; and
the contact detection means is electronically attached to at least one indicator means wherein the indicator means communicates to the user the condition of the integrity of the contact of the conductor means with that of the user selected objects to which the conductor means has been attached.

2. The cable management and contact monitoring system of claim 1 wherein the user selected objects are a computer connected by the conductor means to at least one computer electronically attached input and/or output device.

3. The cable management and contact monitoring system of claim 1 wherein the user selected objects are:
a patient;
a fetal monitor;
a fetal monitor detection means electronically attached by the conductor means to the fetal monitor and being capable of electronic attachment by the conductor means to the patient; and
a fetal monitor results printer electronically attached by a separate conductor means to the fetal monitor.

4. The cable management and contact monitoring system of claim 1 wherein the user selected objects are:
a patient;
a defibrillator; and
at least one pair of defibrillator paddles electronically attached by the conductor means to the defibrillator and being capable of electrically conductive connection by the conductor means to the patient.

5. The cable management and contact monitoring system of claim 1 wherein the user selected objects are:
a patient;
a heart monitor; and
at least one heart monitor detection means electronically attached by the conductor means to the heart monitor and being capable of electronic attachment by the conductor means to the patient.

6. The cable management and contact monitoring system of claim 1 wherein the user selected objects are:
a patient;
a therapeutic electrical stimulation machine; and
at least one pair of electrical stimulation patient connectors electronically attached by the conductor means to the therapeutic electrical stimulation machine and being capable of electronic attachment by the conductor means to the patient.

7. The cable management and contact monitoring system of claim 1 wherein the user selected objects are:
an electrical device; and
an electrical power supply connected to the electrical device by the conductor means.

8. The cable management and contact monitoring system of claim 1 wherein the indicator means is a light.

9. The cable management and contact monitoring system of claim 1 wherein the indicator means is an LED display.

10. The cable management and contact monitoring system of claim 1 wherein the indicator means is an audible alarm.

11. The cable management and contact monitoring system of claim 1 wherein the indicator means is a computer.

12. The cable management and contact monitoring system of claim 1 wherein the contact detection means is comprised of:
at least one electrical current sensor;
at least one microprocessor electronically attached to the electrical current sensor such that the microprocessor communicates a signal to the indicator means respecting the integrity of the contact with the user selected objects.
